(19) United States
(12) Patent Application Publication
(10) Pub. No.: US 2010/0100403 A1
(43) Pub. Date: Apr. 22, 2010

(54) METHOD AND APPARATUS FOR TRACKING AND ANALYZING ENVIRONMENTAL IMPACT OF PRODUCING PAPER

(75) Inventors: Thomas E. Pollock, Portland, OR (US); Theron M. Jourdan, Portland, OR (US)

Correspondence Address: K&L Gates LLP, P.O. Box 1135, CHICAGO, IL, 60690, US

(73) Assignee: METAFORE, Portland, OR (US)

(21) Appl. No.: 12/254,511

(22) Filed: Oct. 20, 2008

(51) Int. Cl. G06Q 10/00

(52) U.S. Cl. 705/7

(57) ABSTRACT

A system and methods are disclosed for enabling a purchaser to make informed, customized purchasing decisions about a plurality of suppliers based on environmental impact data entered by the suppliers. The system enables a supplier to input data about the environmental impact of production process. The system enables the supplier to grant access permission to the input data to one or more purchasers. The system applies a normalization curve to normalize the data. The system also enables the supplier to identify up-stream production entities. The system enables the up-stream production entities to anonymously input environmental impact data. A purchaser enters a plurality of weight values indicating the relative importance of the environmental impact factors. Based on the inputted data by the suppliers and the up-stream production entities, and based on the weight values, the system provides at least one customized supplier environmental impact score to the purchaser.

### TECHNICAL FIELD

The present system relates in general to supply chain tracking software, and more specifically to a system for enabling suppliers to provide environmental impact data and for enabling purchasers to make informed purchases using weighted analyses of the environmental impact data.

### BACKGROUND

Certain known software enables purchasers of products to compare a plurality of suppliers of the products. Such software enables the purchasers to make determinations regarding which supplier to purchase products from based on factors such as the specifications of the offered product itself, cost of the product, delivery time of the product, and subjective reviews of the supplier. Data provided to the purchaser is frequently data based on the pending transaction—that is, data regarding the particular product to be purchased, the cost of the particular product to be purchased, and the estimated delivery time of the particular product to be purchased.

Certain software has also been developed to document and enable a purchaser to analyze environmental considerations with respect to certain suppliers. For example, certain known software stores data regarding an environmental impact caused by the supplier's production activities. This data indicates environmental impacts such as amounts of pollutants released during the supplier's handling of the product or the amount of energy utilized by the supplier to produce the product. Such software enables the purchaser to view the environmental impact data and to make purchasing decisions based thereon.

For purchasers wishing to purchase products from suppliers whose product was produced in an environmentally friendly way, certain software provides some relevant data. This known software suffers from certain drawbacks, however, which make it unacceptable for enabling purchasers to accurately analyze the environmental impact made the producer of a purchased product.

First, certain known software does not take into account the environmental impact caused by entities which handled the purchased products (or components of the purchased product) up-stream of the supplier in the production chain. That is, if a product is sold by the supplier, known software does not enable a potential purchaser to analyze the impact on the environment caused by the producers of the individual components of the product prior to the components being provided to the supplier. For example, a purchaser of shoes may not know the environmental impact of a rubber-farming entity which provided the rubber for the sole of the shoes to a shoe-manufacturer. This is a substantial shortcoming, as few (if any) products purchased in the modern marketplace are sold by the same entity that collected the raw materials and assembled the product.

Second, known software does not enable customization on a purchaser-by-purchaser basis. Some purchasers may have more weighty concerns about certain aspects of the environmental impact of production not shared by other purchasers. For example, a purchaser of shoes which resells shoes under a retail brand touting environmental friendliness may have less tolerance for harvesting rubber from a certain location than a retail seller of shoes for work-site wear. The latter may be less concerned about the harvesting location of the rubber given that a particular location produces the best rubber for insulating workers from electrical shock while on the job. Known software does not enable these differing purchasers to rank suppliers based on the particular concerns of each.

Third, known software does not assure the confidentiality of any environmental impact information provided by the suppliers. Certain software which enables purchasers to review environmental impact data of potential suppliers relies on the suppliers to enter data indicative of the environmental impact of those suppliers' practices. However, this data can allow the purchaser (or other third party) to reconstruct a supplier's pricing structure, thereby providing a competitive advantage. By freely providing such information, known software disincentivizes suppliers honestly entering robust environmental impact data.

Finally, certain known software provides purchasers with the raw data provided by suppliers, but does not quantify the raw data in a form that is easily understandable by the purchaser. Data from one supplier to another may vary greatly based on differences in reporting techniques by the suppliers, differences in regulatory requirements applicable to the suppliers, differences in unchangeable production factors of the suppliers, or other differences. Thus, known software does not provide a mechanism wherein comparisons between a plurality of suppliers are easily made or useful to a purchaser.

Accordingly, a need exists for software to enable purchasers to easily compare an overall environmental impact of supply chain data for a producer by using customized environmental preferences.

### SUMMARY

The environmental impact data tracking system disclosed herein overcomes the described deficiencies of the prior art by providing a system for enabling a plurality of suppliers to enter data relating to the environmental impact of production of the suppliers' products. The system is further configured to enable entry of up-stream environmental impact data for use in determining an overall environmental impact. The system enables each supplier to indicate a plurality of potential purchasers to whom access is granted. Each purchaser can enter customized weighting data indicating environmental impact categories that are important to the purchaser. The system calculates at least one outcome score quantifying the environmental impact, based on the customized purchaser data, and enables the purchaser to compare a plurality of suppliers without manually analyzing the raw data.

The system disclosed herein enables a supplier to provide. environmental impact data. This data may be entered in the form of a plurality of quantifiable factors regarding environmental impact. The system also enables the suppliers to indicate one or more entities which were involved with the production of the materials of the product prior to the producer's creation of the product. Each of these entities is allowed to anonymously provide data regarding the environmental impact of its role in the product's production. The system does not share the up-stream entity-provided data with the suppliers. The system normalizes the provided data, such as by applying one or more normalization curves or normalization functions to the data supplied by the supplier. The normalized data in one form represents a difference between a collected industry average and the supplier-specific data, thus enabling meaningful comparison between suppliers.

The system further enables the supplier to identify one or more potential purchasers to whom access to the environmental impact data is given. Each potential purchaser may provide weight values for the plurality of quantifiable factors regarding the environmental impact of producing the product. Based on the supplied weight values, the disclosed system determines an outcome such as an outcome score which is usable by the purchaser to quantitatively compare a plurality of suppliers. The outcome score may include a first portion indicating the impact on the environment by the supplier's actions, and a second portion indicating an impact on the environment by any up-stream entities' actions. Alternatively, the outcome score may be a single score representing an aggregation of any data entered by up-stream entities identified by the supplier, but does not indicate to the purchaser the contribution of the up-stream entities to the outcome versus the contribution of the supplier to the outcome. Thus, the outcome score represents an environmental impact of the production of a particular product, rather than the environmental impact of a particular supplier's contribution to the particular product.

Additional features and advantages are described herein, and will be apparent from the following Detailed Description and the figures.

### BRIEF DESCRIPTION OF THE FIGURES

FIG. 1 is a block diagram of an example system architecture for implementing the environmental impact tracking system disclosed herein.

FIG. 2 is a flow chart illustrating an example process for a supplier interacting with the disclosed environmental impact data tracking system.

FIG. 3 is a flow chart illustrating an example process for a potential purchaser interacting with the disclosed environmental impact data tracking system.

FIG. 4 is a screen shot of an example interface displayed by the disclosed system for enabling the potential purchaser to assign weights to a plurality of categories.

FIG. 5 is a screen shot of an example interface for displaying outcome scores for three different suppliers based on the weights assigned by the potential purchaser.

FIGS. 6A to 6C are bar graphs illustrating the contributions of six environmental impact categories to outcome scores of the three different suppliers illustrated in FIG. 5.

### DETAILED DESCRIPTION

The system disclosed herein preferably enables a supplier to enter environmental impact data for a plurality of environmental impact categories. This environmental impact data may represent an environmental impact or producing a particular product manufactured by the supplier. The environmental impact data may be entered on a facility-by-facility basis, a product-by-product basis, or any other suitable basis. The system preferably enables each of the suppliers to input an indication of a plurality of up-stream production entities whose outputted products were used to create the supplier's product. For example, a supplier may indicate that in order to produce its product, the output of two up-stream entities was utilized. The system may then enable each of the up-stream entities to input environmental impact data regarding the environmental impact of producing the output combined in the supplier's product. This environmental impact data may not be accessible to the supplier that identified the up-stream entities to the system.

The system may be configured to enable an administrator or other appropriate party to enter data representing a plurality of industry averages regarding the environmental impact of producing certain products. Preferably, this industry average data is in the form of one or more normalization curves which enable the system to determine a quantity representative of a difference between supplier data and industry average data. For example, an administrator may input a normalization curve indicating an industry average for tons of airborne solid waste generated in the production of such product. If two different entities provide data regarding specific amounts of airborne solid waste produced, the data provided may be normalized using the normalization curve representing industry average data. Alternatively, the data provided may be processed to determine a percentage of a total airborne solid waste which is attributable to a certain product of each of the suppliers, such that if one supplier produces products in different quantities and/or ratios from another produced, the processed data reflecting the differing production efforts may be usable to meaningfully compare the two suppliers.

The environmental impact data tracking system disclosed herein preferably enables a potential purchaser to indicate a plurality of weights in association with a plurality of environmental impact factors. The environmental impact factors may correspond with environmental impact data entered by the suppliers, and preferably represent particular environmental concerns of the potential purchaser. For example, a particular potential purchaser may associate a relatively high weight with an amount of carbon dioxide released into the environment during the production of a particular product. The disclosed system may also enable the potential purchaser to select a plurality of suppliers or producers with stored environmental impact data to which to apply the weighted impact factors. Alternatively or additionally, the disclosed system enables the potential purchaser to indicate a particular generic description of a product that the potential purchaser wishes to purchase. The system applies the weighted environmental impact categories to the data associated with the indicated producers who have allowed access to the potential purchaser, and generates a score indicating the environmental impact of each supplier or producer as applicable to the potential purchaser.

Calculation of the score based on the potential purchaser's weighted preferences may be based not only on the environmental impact data entered by the supplier, but also on the environmental impact data entered by the up-stream entities. It should be appreciated that the score may include at least two numerals, such as a first numeral representing the environmental impact attributable to the supplier and a second numeral attributable to the upstream entities involved in production. Alternatively, the score may be a single numeral representing the overall environmental impact of producing a product, without indicating a portion of the numeral attributable to the up-stream entities. Thus, any representation of the environmental impact of the up-stream entities may be aggregated in the score provided to the potential purchaser.

The disclosed system may calculate an aggregated outcome score based on the upstream activities of a plurality of suppliers by calculating an outcome score for each of the suppliers as described above (i.e., by applying the potential purchaser's weighted values to the supplier-entered environmental impact data): The disclosed system may assign a percentage of impact for a final product to each of the suppliers in the supply chain. This percentage may be automatically determined (e.g., based on industry standard or average data) or may be determined based on data provided by the suppliers in the supply chain (e.g., based on a supplier's indication that each of three upstream suppliers contributed to 10% of the environmental impact of a finished paper product). The disclosed system may calculate an aggregate score by multiplying each supplier's calculated outcome score by that supplier's percentage of impact and by calculating a sum of the values for each supplier chain. The disclosed system may display only the final outcome score (i.e., the sum), or may display a representation of the contribution of each of the upstream suppliers to the final outcome score. It should be appreciated that this mechanism for calculating the aggregate outcome score is provided by way of example and is not intended to be limited. In various embodiments, any suitable formula for calculating such an aggregate outcome score may be utilized.

The disclosed system is preferably applicable to determine the environmental impact of producing frequently used, raw-material-intensive products. Purchasers of such products (i.e., for retail sale) may view the additional, potentially avoidable environmental impact associated with the production of such products (i.e., in addition to the raw materials themselves) as particularly important to purchasing decisions.

For example, the disclosed system may be usable to track the environmental impact associated with the production of paper and paper products. The system may enable paper mills which produce finished paper products to enter data indicating the environmental impact of such production. Paper mills may indicate a quantity of raw materials which are recycled materials, a quantity of released waste gasses, a quantity of particulate solid matter released in the air, and/or any other suitable environmental impact data. This data may be entered on a mill-by-mill basis, on a paper product-by-paper product basis, or on any other suitable divided basis. The paper mills may additionally identify any up-stream suppliers, such as loggers, pulp suppliers, shippers, and/or any other suitable up-stream entities which conduct activity related to the production of the finished product which has an environmental impact. The supplier may identify certain purchasers to whom access to the environmental data should be granted. Such purchasers may provide weight values associated with a plurality of environmental impact factors. For example, a purchaser may provide a weight value indicating that a quantity of recycled material is a particularly important environmental factor to that purchaser. The system may then apply the weight factors to the entered data about a plurality of suppliers, and may assign a score to each supplier. The score may represent a quantifiable representation of the alignment of each supplier with a purchaser's environmental goals, and may thus be usable in making a decision about which supplier to purchase a particular paper product from.

It should be appreciated that the disclosed system is not limited in application to determining the environmental impact of a production chain for the production of paper. Rather, the disclosed system is usable to track any suitable characteristic of production of a product, such as a quantity of employed individuals involved in the production of a product from a given region or country, a plurality of sources of raw materials, an amount of time for production of a product, or any other suitable characteristic of production of a product. In another embodiment, the disclosed system is usable to track the supply chain characteristics of manufactured goods. For example, if a purchaser wishes to purchase a motorcycle, the disclosed system is usable to track the supply chain of certain parts of the motorcycle, such as to track manufacturing characteristics of the suspension system or engine of the motorcycle.

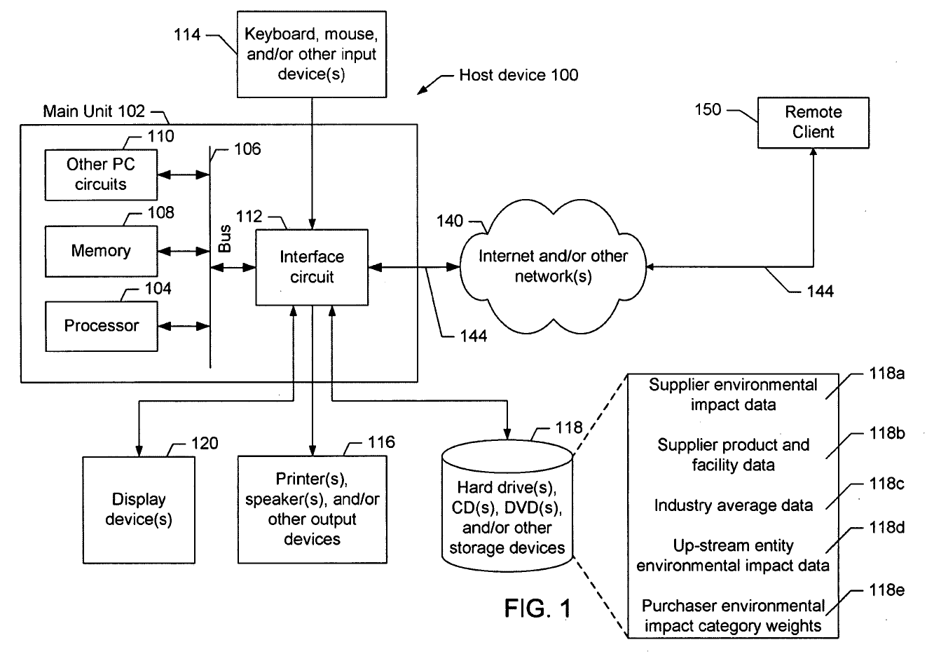

Referring now to the figures, FIG. 1 is a block diagram of an example system architecture for implementing the environmental impact data tracking system disclosed herein. Specifically, FIG. 1 illustrates a schematic block diagram of a server (e.g., host device 100) for implementing the environmental impact data tracking system. In the example architecture, the host device 100 includes a main unit 102 which preferably includes one or more processors 104 electrically coupled by an address/data bus 106 to one or more memory devices 108, other computer circuitry 110, and one or more interface circuits 112. The processor 104 may be any suitable processor. The memory 108 preferably includes a combination of volatile memory and non-volatile memory.

Preferably, the memory 108 stores a software program that causes the host device 100 to operate as a server for receiving data from a plurality of suppliers and potential purchasers and for performing calculations based on that data. This software program may be executed by the processor 104 in any suitable manner. The memory 108 may also store digital data indicative of documents, files, programs, web pages, etc. retrieved or received from one or more remote clients such as remote client 150.

The interface circuit 112 may be implemented using any suitable interface standard, such as an Ethernet interface and/or a Universal Serial Bus (USB) interface. One or more input devices 114 may be connected to the interface circuit 112 for entering data and commands into the main unit 102. For example, the input device 114 may be a keyboard, mouse, touch screen, track pad, track ball, isopoint, and/or a voice recognition system.

One or more displays 120 or printers, speakers, and/or other output devices 116 may also be connected to the main unit 102 via the interface circuit 112. The display 120 may be a cathode ray tube (CRT), liquid crystal display (LCD), or any other type of display. The display 120 may generate visual displays of screen shots and/or digital displays of sets of events which are relevant to the screen shots. The visual displays may include prompts for human input, run time statistics, calculated values, data, etc. For example, the display 120 may be used to enable a server administrator to monitor the functionality of the host device 100 and to ensure that the host device 100 remains in signal communication with the remote client 150.

One or more storage devices 118 may also be connected to the main unit 102 via the interface circuit 112. For example, a hard drive, CD drive, DVD drive, tape drive, and/or any other appropriate storage devices may be connected to the main unit 102. The storage devices 118 may store data entered into the disclosed environmental impact data tracking system such that calculations may be performed on the data locally. Specifically, the storage device may store supplier-entered environmental impact data 118a, supplier product and facility data 118b, industry average data such as data in the form of normalization curves 118c, up-stream entity environmental impact data 118d, and/or purchaser-entered environmental impact category weighting data 118e.

The host device 100 may exchange data with at least one remote client such as remote client 150 using a connection 144 to the network 140. The network connection 144 may be any suitable network connection, such as an Ethernet connection, a digital subscriber line (DSL), a telephone line, a coaxial cable, etc. Access to a host device 100 may be controlled by appropriate security software or security measures. An individual potential purchaser's access can be defined by the host device 100 and limited to certain data and/or actions. Accordingly, potential purchasers of the system interacting with a remote client 150, such as potential purchasers acting on behalf of suppliers, purchasers, or up-stream entities, may be required to register with one or more host devices 100. The remote client 150 preferably enables a remote user to weight a plurality of environmental impact categories which indicate that user's environmental impact preferences.

It should be appreciated that the schematic architecture diagram illustrated in FIG. 1 is one example architecture for implementing the disclosed system. In other example architectures, one or more potential purchaser acting on behalf of one or more of the purchaser, the supplier, the up-stream entity, and a database administrator interacts with the host device 100 by accessing the host device directly using input devices 114 and display devices 120. The system may thus be implemented fully locally (i.e., access does not occur via the network 140) or partially locally (i.e., access by one or more potential purchasers occurs locally and access by one or more other parties occurs via the network 140). Thus, any suitable hardware configuration may be utilized.

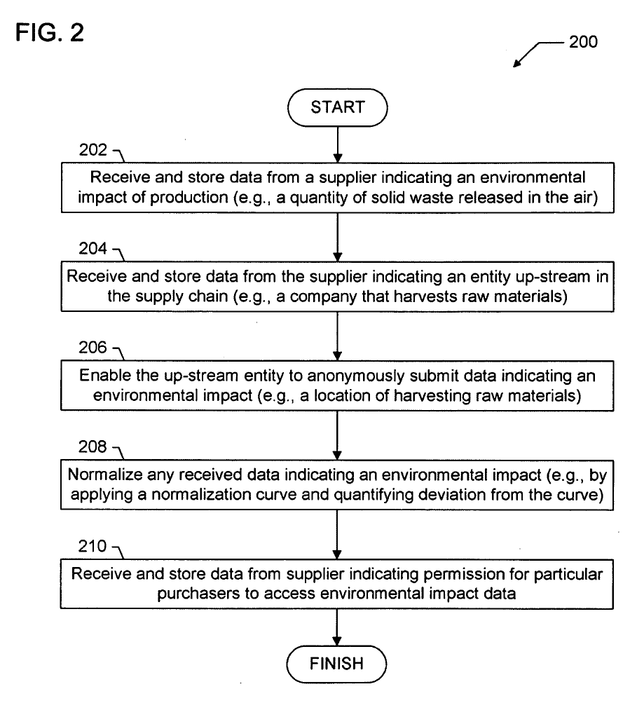

FIG. 2 is a flow chart illustrating an example process 200 for a supplier interacting with the disclosed environmental impact data tracking system. Although the example process 200 for a supplier interacting with the disclosed system is described with reference to the flow chart illustrated in FIG. 2, it should be appreciated that many other methods of enabling supplier interaction are contemplated. For example, the order of certain of the blocks may be changed, and certain of the blocks described are optional.

The process 200 begins when the server (i.e., the host device 100) receives data from a supplier indicating an environmental impact of production (block 202). For example, the data received by the server may indicate a quantity of solid waste released in the air (block 202). This environmental data may be entered in varying degrees of granularity. For example, the disclosed system may enable the supplier to enter environmental impact data for a particular product, for a particular facility, or for the supplier's entire supply operation.

The received data preferably enables the server to quantify the indicated environmental impact—that is, the received data is preferably a quantity selected from a continuum of quantities. For example, if the received data indicates solid particulate waste released into the air, the disclosed server may be configured to accept a range of acceptable values measured in grams of particulate solid waste per year. It should be appreciated that by so limiting the format of the received data, the disclosed server may ensure comparability between similar data received from a plurality of different suppliers. The disclosed server may also ensure that the values entered for each environmental impact category are reasonable (or at least possible) based on the category.

The disclosed system preferably also receives data from the supplier indicating at least one up-stream entity in the supply chain of a given product (block 204). For example, the disclosed system may enable a potential purchaser to identify a company which provides the supplier with raw materials used to create the final product (block 204). Alternatively, the disclosed system may enable the supplier to identify transportation companies, harvesting companies, or any other appropriate type of entity which is involved in the supply chain of the product up-stream of the supplier. It should be appreciated that enabling the supplier to identify such up-stream entities enables more comprehensive encapsulation of the environmental impact associated with producing a particular product, as described below. That is, it should be appreciated that merely quantifying and analyzing the environmental impact attributable to the supplier (i.e., the last in a potentially lengthy chain of entities involved in producing the product) is an incomplete representation of the total environmental impact.

After receiving data indicating the up-stream entities, the disclosed system may enable each of the up-stream entities to anonymously submit data indicating the environmental impact of that entity's role in production (block 206). For example, the disclosed system may enable the up-stream entity to indicate a characteristic of a harvesting location (block 206), such as a cultural impact of harvesting raw materials on groups of people indigenous to the harvest area. As with respect to the supplier-entered impact data, the disclosed system may enable the up-stream suppliers to enter data with varying degrees of granularity. For example, the system may enable the up-stream suppliers to enter data at the product level, at the facility level, or at an entire up-stream supplier activity level. This data may be anonymous in that it is not visible to the supplier which originally indicated the up-stream entity. It should be appreciated that such anonymity may prevent the supplier from deducing the up-stream suppliers' revenue streams and profit margins; such deduction may represent a competitive advantage to the supplier.

After the supplier has entered data representing the environmental impact of its processes, the disclosed system may normalize the entered data to ensure meaningful comparison with the data of other suppliers (block 208). To do this, the disclosed system may apply a normalization curve based on a characteristic of the supplier, such as a mill type employed by the supplier. The normalization curve data may be composed of data collected about a plurality of specific mill types, and may be available to an entire industry. Alternatively, the normalization curve data may be composed of data which is collected based on a customized set of normalization criteria, and may be developed to specifically operate with the disclosed system.

The normalization curve data may define a plurality of normalization curves. The curves may include normalization data which is specific to a given product, component of a product, mill or factory type, geographical location, or any other suitable breakdown of supply chain data. The normalization data preferably indicates an average set of data based on the breakdown characteristic for the data, and enables a set of data for a particular facility to be compared against the average. For example, a normalization curve may represent a function which, which applied to a set of data, quantifies the deviation of the data from the normalization curve.

The set of normalization curves applied to the data may differ between the supplier and an any identified up-stream entities. For example, the normalization curve applied to the supplier may result from different industry average data, such as industry average data for production of a final good, than the normalization curve applied for up-stream entities. Moreover, the level of granularity of the industry averages indicated by the normalization curves may vary. For example, certain of the normalization curves may enable normalization of data at a product level, while certain of the normalization curves may enable normalization of data at a facility or producer level.

Alternatively, the normalization data may allocate an appropriate portion of data representing environmental impact to a particular product. For example, if a supplier generates two products, one of which represents 30% of its total activity and another of which represents 70% of its total activity, the disclosed system may allocate 30% of the environmental impact to the first product and 70% of the environmental impact to the second product. For analysis performed using this data, the disclosed system may thus the normalized data if a purchaser seeks analysis of either single product (but not both), as described below.

A supplier's interaction with the disclosed system may end with the server data from the supplier indicating a permission or a plurality of permissions with respect to the inputted environmental impact data (block 210). The data may indicate one or more purchasers, such as one or more suppliers selected from a list of purchasers registered with the server, for whom the server may perform calculations on the supplier's data (block 210). The server may store such data in an appropriate database, such as on the storage device 118, for future use (block 210). In a further embodiment, the disclosed system also enables the up-stream entities to provide permissions which define the ability of other users of the disclosed system to access the up-stream entities' data. This permission data may limit the ability of the suppliers to access the data and/or the ability of the potential purchasers to access the data.

Preferably, the disclosed system enables the suppliers and up-stream entities to provide the permissions information based on a list of users of the system. For example, the system preferably displays a list of each supplier and/or each potential purchaser which has registered with the system, and enables the permission-granting entity to select one or more of the suppliers and/or purchasers from the list. This ensures that the permission-granting entity will not erroneously grant permission to a particular entity due to typographical or stenographical errors.

The disclosed system may enable each supplier to indicate the desired permissions to its supplied data on a purchaser-by-purchaser basis. The permission may also be granted on a product-by-product basis, on a facility-by-facility basis, or based on any other appropriate segmentation of the supply chain of the products offered by the supplier.

The disclosed system may enable each individual purchaser to view the permissions granted to it upon entry by the suppliers. For example, if a particular supplier indicates that it wishes to grant permissions to a particular purchaser to view supply-chain data for a first product and not for a second product, the disclosed system may display these permissions to the potential purchaser.

The disclosed system may thus enable the supplier to determine an audience which is able to analyze its environmental impact data. Moreover, the server may provide adequate security, such as security similar to that used for online banking institutions, to ensure the suppliers that any entered data will not be disseminated beyond the list of purchasers to whom permission was granted.

It should be appreciated that the process 200 may be repeated a plurality of times by a single supplier. For example, a supplier having a plurality of production facilities may repeat the above data entry steps for each of the facilities, such that analysis can be performed on a facility-by-facility basis. Alternatively or additionally, a supplier that produces more than one product may repeat the process 200 for each product, enabling the analysis described below to be performed on a product-by-product basis.

It should be further appreciated that certain suppliers may not indicate any up-stream entities. These suppliers may not do so because they wish not to identify the entities, or because such entities may not exist. Moreover, the disclosed system may be configured to function (i.e., to enable purchasers to perform environmental impact analyses) on data supplied by suppliers even if the suppliers have not indicated up-stream entities or if the entities have not submitted data.

The disclosed system may be provided on a paying basis to suppliers such as those utilizing the process 200 described above. The disclosed system may also require any identified up-stream entities to pay for the right to provide supply-chain data for review by potential purchasers. Alternatively, access to the system may be provided for free to up-stream entities wishing to input environmental impact data as described. It should be appreciated that such free access may be provided because, although suppliers (i.e., parties making sales based on the system's calculations) may have an incentive to provide full and accurate data, the same incentive may not exist for up-stream entities. Thus, in the interest of providing environmental impact data which is as accurate as possible, the disclosed system may enable up-stream entities to input data without paying any fee.

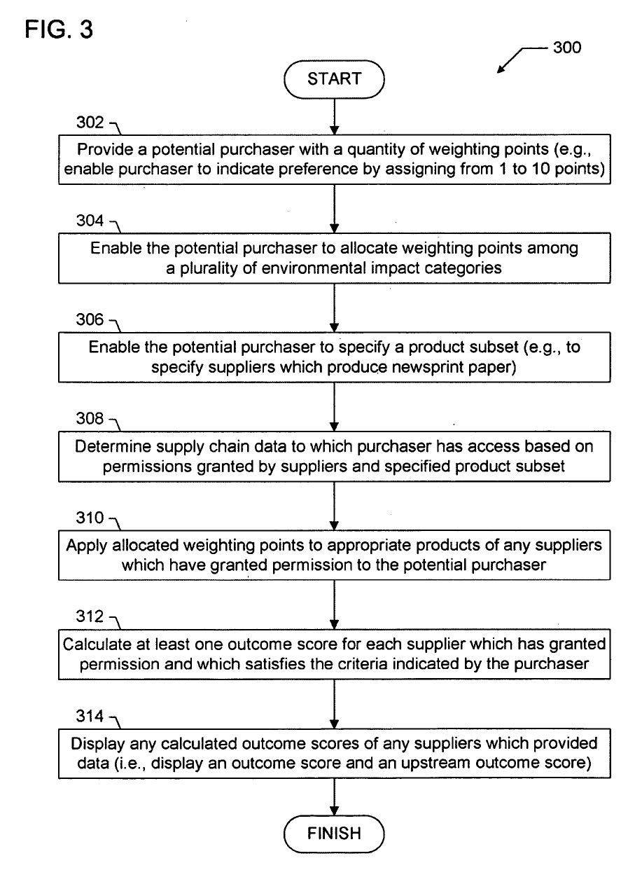

FIG. 3 is a flow chart illustrating an example process 300 for a potential purchaser interacting with the disclosed environmental impact data tracking system. Although the example process 300 for the potential purchaser interacting with the disclosed system is described with reference to the flow chart illustrated in FIG. 3, it should be appreciated that many other methods of enabling purchaser interaction are contemplated. For example, the order of certain of the blocks may be changed, and certain of the blocks described are optional.

The disclosed system enables a potential purchaser to begin the environmental impact data analysis process by providing the potential purchaser with a quantity of weighting points (block 302). For example, the disclosed system may enable the potential purchaser to indicate a preference for each of a plurality of environmental impact category by assigning each category a score from 1 to 10. Alternatively, the disclosed system may provide the potential purchaser with a total of 100 weighting points to allocate among the environmental impact categories.

The disclosed system then enables the potential purchaser to allocate the weighting points among a plurality of environmental impact categories (block 304). For example, the disclosed system may maintain three distinct categories of environmental impact data. The system may enable the potential purchaser to indicate a score from 1 to 10 for each of the three categories. The purchaser in this embodiment is not constrained from one category to the next—that is, the purchaser may indicate a score of 10 for each of the three categories, or may indicate a score of 1 for each of the categories. Alternatively, the disclosed system may enable the purchaser to allocate the 100 total points between the three categories. In this embodiment, the potential purchaser may determine that the first category is twice as important as each of the second and third categories, and may allocate 50 points to the first category, 25 points to the second category, and 25 points to the third category. It should be appreciated that enabling the potential purchaser to allocate points as described enables the potential purchaser to assign a set of relative importances to each of a plurality of categories. That is, the system enables the potential purchaser to quantify its environmental impact concerns for analysis by the system.

The system may thus provide any suitable weighting category. For example, the system may enable the potential purchaser to assign a percentage to each category, which the system may utilize to assess relative importance. The system may alternatively enable the potential purchaser to select from a plurality of words describing the purchaser's concern for the category, and may weight the categories based on the words chosen. It should be appreciated that any mechanism for enabling the potential purchaser to indicate a set of relative importances is contemplated by the instant disclosure.

The disclosed system also enables the potential purchaser to specify a type of product, the environmental impact data of which to perform a plurality of calculations on (block 306). For example, if the disclosed system enables a potential purchaser to determine the environmental impact of producing paper, the system may enable the potential purchaser to indicate “newsprint” as a desired product. This may enable the system to narrow down the supplier data on which calculations are performed. Alternatively, the system may enable the potential purchaser to select a subset of the supplier data by specifying a particular supplier, a particular region of suppliers, a particular type of supplier facility, or any other common characteristic by which the potential purchaser wishes to narrow down supplier data.

The disclosed system determines, based on the product subset specified by the potential purchaser, any supply chain data to which the potential purchaser has access (block 308). For example, if the potential purchaser indicates that it wishes to buy a particular product, the disclosed system determines which suppliers of that particular product have granted the potential purchaser permission to access the supply chain data. The disclosed system may display the set of suppliers which have granted such appropriate permission, as well as any products for which supply chain data has been entered, to the potential purchaser prior to enabling the potential purchaser to enter data about a desired product subset.

The disclosed system then applies the allocated weighting points to the data entered by the suppliers about the appropriate subset of products (or other subset of supplier data) (block 310). Preferably, the disclosed system only applies the weighted points to supplier data provided by suppliers which (a) fit the category selected by the supplier, such as suppliers which produce newsprint, and (b) have granted permission to the potential purchaser to have the system perform analysis on the supplier's data. It should thus be appreciated that the disclosed system enables a supplier to indicate a subset of potential purchasers who may analyze that supplier's data, and also enables a potential purchaser to specify a subset of supplier data to analyze according to the potential purchaser's preferences. In various embodiments, the disclosed system enables the potential purchaser to specify certain suppliers whose data it does not wish to analyze, such as suppliers with whom the potential purchaser has had prior business dealings that did not end amicably.

The system calculates an outcome score for each of a plurality of suppliers which have granted permission to the potential purchaser and which satisfy the criteria indicated by the potential purchaser (i.e., suppliers which produce newsprint) (block 312). This outcome score is based on the customized allocation indicated by the potential purchaser, such that the score reflects environmental impact categories which the potential purchaser views as important (block 312). It should be appreciated that the system may calculate only a single outcome score which is indicative of the environmental impact caused by both the supplier and any indicated up-stream entities. Alternatively, the system may calculate at least two outcome scores, wherein one outcome score is indicative of the environmental impact score of the supplier and wherein another outcome score is indicative of the environmental impact score of any upstream entities which were involved in the production of the indicated product. The system displays a visual representation of the any outcome scores calculated, such as by displaying a supplier outcome score and an upstream outcome score (block 314).

In a preferred embodiment, the disclosed system enables an operator to provide a quantifiable indication of an importance for each of a plurality of environmental impact categories. That is, the disclosed system preferably enables a potential purchaser to indicate the importance of each of a plurality of categories on a scale ranging from less important to more important. For example, the system may enable the potential purchaser to rank each environmental impact category by assigning a value to each category ranging from 1 to 10, with 1 indicating that the category is less important to the purchaser, and 10 indicating that the category is more important to the purchaser.

Alternative mechanisms are also contemplated for enabling the purchaser to weight a plurality of environmental impact categories. For example, the disclosed system may determine a plurality of percentages based on the allocation indicated by the potential purchaser. If the potential purchaser is provided 100 allocatable points, the disclosed system determines a percentage based on the number of points allocated to an environmental impact category. In a simple example, a purchaser allocates 75 points to a raw materials usage category and 25 points to a water pollution category. It should be appreciated that such an allocation indicates that the potential purchaser views raw materials usage as three times more important than water pollution.

Continuing the simple example, the disclosed system may contain environmental impact data entered by two suppliers relating to the suppliers' production of newsprint. The normalized data may indicate that a first supplier has a score relating to raw materials usage of 43.5 and a score relating to water pollution of 90.2. As discussed, this data may be normalized based on the application of a normalization curve or other suitable representation of industry average environmental impact data. It should be appreciated that these two scores may not be comparable to one another—that is, comparing the two numerals may not indicate which score is “better” than the other score. The normalized data may further indicate that a second supplier has a score relating to raw materials usage of 60.2 and a score relating to water pollution of 47.4. Preferably, comparison of a first supplier's scores with a second supplier's scores within a same environmental impact data category indicates a “better” supplier with respect to that category. Thus, in the example above, the second supplier is better than the first supplier in the raw materials category, but inferior to the first supplier in the water pollution category.

The disclosed system may calculate an outcome score for each supplier, based on the allocated points, by multiplying the percentage associated with the potential purchaser's categories by each supplier's normalized scores for those categories, and summing the results for a given supplier For the first supplier above, the system may multiply the potential purchaser's 75% raw materials usage allocation by the first supplier's 43.5 score and the potential purchaser's 25% water pollution allocation by the first supplier's 90.2 score and sum the results. Thus, the outcome score for the first supplier may be 55.2. A similar calculation may result in an outcome score for the second supplier of 57.0 The outcome scores for a plurality of suppliers may reflect a comparable, quantifiable representations of the suppliers based on the potential purchaser's preferences. Thus, it should be appreciated that the second supplier, though possessing a substantially lower water pollution score than the first supplier, may be preferable for the potential purchaser based on the higher raw materials usage score.

If the disclosed system is configured to calculate a separate outcome score for any upstream entities, the system may calculate such a score in a substantially similar way to the method described above. It should be appreciated that the normalization curves used to normalize data entered by up-stream suppliers may differ from those used to normalize the supplier data. It should be further appreciated that the disclosed system may apply one or more reduction factors to the outcome score calculated for an up-stream supplier, such that the up-stream outcome score does not overwhelm or skew the supplier outcome score. For example, if an up-stream supplier contributed only a relatively small amount to the end product (i.e., if the up-stream supplier supplied materials for packaging the end product), the disclosed system may reduce the up-stream outcome score based on the relatively small quantity of the up-stream product used by the supplier.

It should be further appreciated that any appropriate mechanism for calculation the outcome score is contemplated by the disclosed system. For example, the outcome score may be further normalized based on a quantity of products to be purchased. The outcome score may be calculated based, in part, on a price the potential purchaser wishes to pay or based on a time-frame for delivery. The outcome scores may be based on preferences stored for one or more potential purchasers, such that suppliers with whom the potential purchaser has a preexisting relationship may receive a higher score than a supplier without such a relationship, even if the quantifiable environmental impact data is identical.

Additionally, the disclosed system may award certain suppliers with “credits” or other incentives for performing certain production actions. The system may add these credits to the outcome scores of the suppliers prior to displaying the outcome scores to the potential purchaser. For example, the disclosed system may award a credit if a supplier has constructed a new factory within the preceding five years. The disclosed system may award a credit if the supplier has embarked upon an appropriate program, such as a program to make a factory more “green” or more environmentally friendly. The disclosed system may award a credit based upon domestic factory locations, based on monetary contributions to appropriate recycling or conservation programs, or based on any other suitable, desirable behavior by a supplier.

The disclosed system may provide one or more credits to a supplier based on information submitted by the supplier. For example, the disclosed system may provide one or more credits to a supplier if the supplier submits evidence of awards which the supplier has won and sustainability reports created by the supplier and/or an outside, third party. Further, the disclosed system may enable a supplier to submit information which does not fall within a predefined category. For example, the disclosed system may enable the supplier to submit information regarding initiatives independently undertaken by the supplier. Based on this submitted information, the disclosed system may automatically determine (or an operator of the system may determine) that the supplier which submitted the information is deserving of one or more credits.

In one embodiment, the disclosed system enables the potential purchaser to define a set of credit criteria. In this embodiment, the disclosed system may use the credit criteria of a particular potential purchaser to determine whether to apply one or more credits to the outcome score of a supplier based on the type of information submitted by the supplier. In one embodiment, the disclosed system enables each potential purchaser to manually determine whether to apply any credits for any individual purchasers based on the information submitted, such as by providing the purchaser with all such information submitted by a supplier at the time of calculation of the outcome score.

In various embodiments, the disclosed system is configured to enable a potential purchaser to assign credits based on non supply-chain based activities which have particular importance to that purchaser. For example, the disclosed system may enable the potential purchaser to indicate that if a supplier endows a chair at a university in a particular field of study. Based on such an endowment made by a particular supplier, the disclosed system may apply one or more credits to the supplier's outcome score upon final calculation of the score. The above examples are not intended to be exhaustive; it should be appreciated that the instant disclosure contemplates any type of customizable credit applicable to increase or enhance the outcome score of a supplier.

The disclosed system may enable hierarchical environmental impact categories to which the potential purchaser may allocate points. For example, the disclosed system may enable the potential purchaser to allocate 100 points to a plurality of top-level environmental impact categories. One of these top-level categories may include at least two sub-categories. The disclosed system may enable the potential purchaser to allocate points among the sub-categories. This may be accomplished by enabling the potential purchaser to allocate the points allocated to the top-level category among the sub-categories. Preferably, the system enables the potential purchaser to assign a score from 1 to 10 to each of the sub-categories. Alternatively, the system enables the potential purchaser to further allocate the points allocated to the top-level category amongst the sub-categories. For example, if the potential purchaser allocated 23 points to a top-level category, the system may enable the potential purchaser to allocate those 23 points among two sub-categories, such as by allocating 18 points to a first sub-category and 5 points to a second sub-category. Alternatively, the disclosed system may enable the potential purchaser to allocate 100 points among the sub-categories of any top-level category, such that changing the points allocated to the top-level category does not impact the points allocated to the sub-categories.

It should be appreciated that if the disclosed system enables the potential purchaser to allocate points among a plurality of sub-categories, the disclosed system may also require the suppliers to indicate performance data for the same sub-categories. This may enable the system to perform the adequate weighting of the suppliers' performance within the sub-categories based on sub-category weighting provided by a potential purchaser.

The disclosed system may also enable a potential purchaser to store a plurality of weighting profiles. In the above-described process 300, the system enables the potential purchaser to specify one set of weighting values, such as by allocating a plurality of points. Alternatively, the disclosed system may enable the potential purchaser to specify more than one such set of weighting values, and may enable the potential purchaser to select from among the weighting profiles while generating various outcome scores.

In the embodiment described above, the outcome scores are calculated based solely on the data entered by the plurality of suppliers. It should be appreciated that the disclosed system may similarly calculate outcome scores based on the data entered by the suppliers in addition to data entered by any appropriate up-stream entities in the supply chain. For example, the disclosed system may generate a total environmental-impact outcome score for a given product or a given supplier by calculating a weighted average. For example, the weighted average may use normalized data in the same way as above, wherein the normalization includes weighting the data entered by the supplier and any appropriate up-stream entities. For example, the supplier's data may account for 50% of the normalized data and the data entered by all the up-stream entities may account for the remaining 50% of the normalized data.

The disclosed system enables a supplier to act as a potential purchaser. That is, the disclosed system enables a supplier, which enters data regarding the environmental impact of the products supplied, to weight a plurality of environmental impact categories. The system also enables the supplier to indicate a desired up-stream product, such as a raw material product, which the supplier wishes to purchase. Based on the normalized environmental impact data for the up-stream product, the disclosed system calculates an outcome score for each up-stream supplier which produces the raw material, customized to a particular supplier. Thus, it should be appreciated that the disclosed system enables certain entities to function as both suppliers and as potential purchasers, and provides customized data indicating environmental impact of up-stream supply chain activity to entities at varying levels of the supply chain.

It should be appreciated that the disclosed system may enable each of the suppliers to enter a brief narrative about itself. Thus, the disclosed system may display a narrative authored by each supplier accompanying the outcome scores generated as described above. This narrative may represent an opportunity for the suppliers to make a case for itself to potential purchasers, such as by touting particular programs which the supplier has in place, identifying key technology possessed by the supplier, or any other relevant information the supplier wishes to communicate to the purchaser. Thus, the disclosed system may provide guidance, but the calculated outcome scores may not represent guaranteed decisions made by the potential purchaser.

The processes 200 and 300 may operate substantially simultaneously, and may each be repeated during operation of the system independently of one another. For example, although process 300 preferably does not operate until after at least one supplier has entered data about its environmental impact, as illustrated in process 200, the disclosed system enables suppliers to continue updating environmental impact data while simultaneously enabling purchasers to calculate outcome scores for products about which data has already been entered. Thus, it should be appreciated that the disclosed processes 200 and 300 may run simultaneously or one after the other, depending on the desired calculations of the potential purchasers.

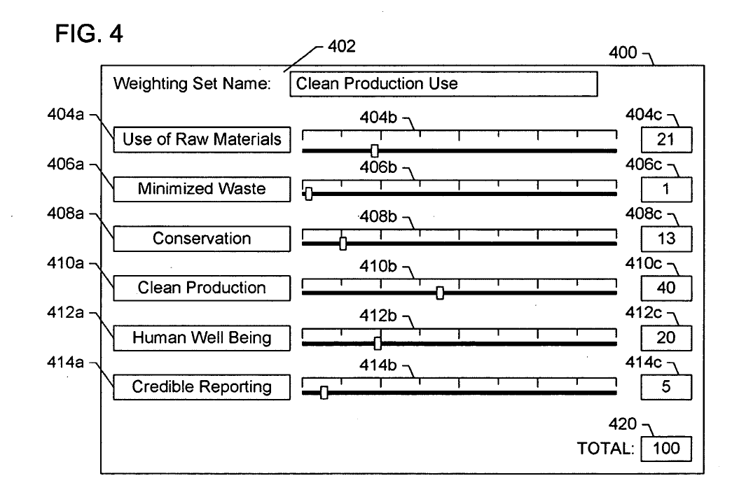

FIG. 4 illustrates a screen shot 400 of an example interface displayed by the disclosed system for enabling the potential purchaser to assign weights to a plurality of categories. The interface illustrated in screen shot 400 enables a potential purchaser to indicate a weight value for each of six categories. The set of weight values make up a weighting set, which, as noted above, may be one of a plurality of weighting sets. In the illustrated screen shot 400, the potential purchaser has indicated a weighting set name of “Clean Production Use,” as indicated by numeral 402.

The weighting set includes specific weighting values associated with each of six different categories of environmental impact data. Specifically, the illustrated screen shot 400 enables a potential purchaser to input weighting values for the categories including a Use of Raw Materials category 404a, a Minimized Waste category 406a, a Conservation category 408a, a Clean Production category 410a, a Human Well Being category 412a, and a Credible Reporting category 414a. The weighting values of each category are settable using sliders 404b, 406b, 408b, 410b, 412b, and 414b, as illustrated. A value indicated by a position of each slider, which is associated with one of the six categories, is displayed in the value display areas 404c, 406c, 408c, 410c, 412c, and 414c.

It should be appreciated that in the illustrated example screen shot 400, the disclosed system is configured to enable the potential purchaser to enter values such that the total value is 100, as indicated by the Total display area 420. Thus, the weighting values indicated in the value display areas 404c, 406c, 408c, 410c, 412c, and 414c represent a relative importance of each category, such that the value entered for the Clean Production category 410a is twice the value entered for the Human Well Being category 412a (i.e., 40% versus 20%). As discussed, the system may alternatively enable the potential purchaser to enter any desired numeral for each of the categories, and may calculate a relative importance value (e.g., a percentage) transparently.

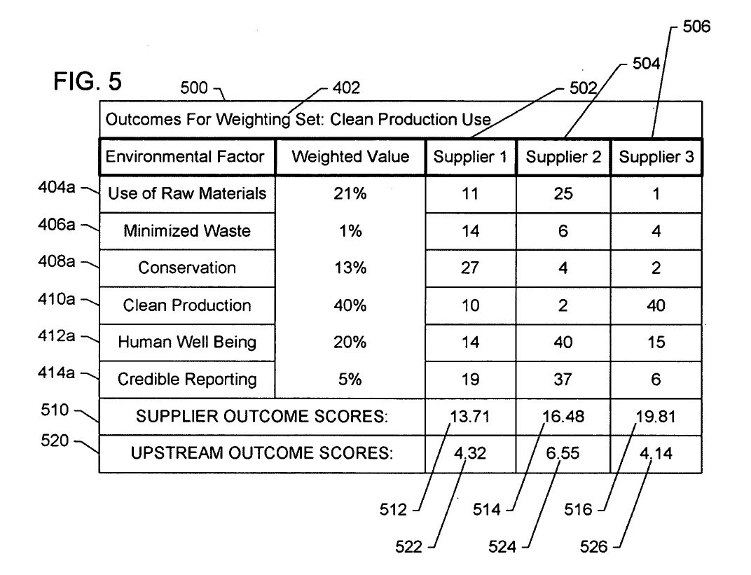

FIG. 5 is an example screen shot 500 of an example interface for displaying outcome scores for three different suppliers based on the weights assigned by the potential purchaser. Specifically, the screen shot 500 illustrates an interface which includes a plurality of rows and a plurality of columns, such as columns 502, 504, and 506. As illustrated, the screen shot 500 displays outcomes calculated by the system based on the weighing set entitled “Clean Production Use” 402. To this end, the screen shot 500 includes indications of the six environmental impact data categories 404a, 406a, 408a, 410a, 412a, and 412a. It should be appreciated that the weighted values illustrated in the Weighted Value column of screen shot 500 reflect the relative importance of the environmental impact data categories as illustrated in value display areas 404c, 406c, 408c, 410c, 412c, and 414c of FIG. 4.

FIG. 5 includes columns 502, 504, and 506, which contain environmental impact data as entered by three different suppliers. Specifically, data entered by Supplier 1 is displayed in column 502, data entered by Supplier 2 is displayed in column 504, and data entered by Supplier 3 is displayed in column 3 506. It should be appreciated that, as illustrated, this data reflects only data entered by the individual suppliers. In the illustrated embodiment, any up-stream suppliers' environmental impact data is not displayed in the chart 500.

Alternatively, the data displayed in chart 500 may reflect data entered by the three individual suppliers and data entered by up-stream entities in the supply chain for a particular product, facility, or supplier. In this embodiment, the disclosed system does not indicate the data entered by any up-stream entities separately from any data entered by the suppliers themselves, as this data is treated confidentially and is only displayed as aggregated with the supplier data. It should be appreciated that this aggregate display mechanism enables the up-stream entity data to remain hidden from both suppliers and potential purchasers.

In the illustrated embodiment, each column 502, 504, and 506 includes the normalized data for each supplier for each of the six environmental impact data categories, as well as an Outcome Score 510 for the supplier based on the selected weighting set 402. In the illustrated embodiment, the Outcome Score 512 for Supplier 1 is 13.71, the Outcome Score 514 for Supplier 2 is 16.48, and the Outcome Score 516 for Supplier 3 is 19.81. It should be appreciated that the outcome scores 510 were generated in the illustrated embodiment by multiplying the weighted value for each environmental impact data category by a supplier's normalized data for that category and summing the products for each of the suppliers. Thus, for example, Supplier 1's outcome score is determined by the following equation:

Outcome Score=(21% *11)+(1%*14)+(13%*27)+(40%*10)+(20%*14)+(5%*19).

It should be appreciated that the Outcome Scores 510 may be indicative of relative quality of each of the suppliers with respect to the preferences of the potential purchaser which provided the Clean Production Use Weighting Set 402. Thus, based on the outcome scores alone, Supplier 3 appears to provide the best alignment of environmental impact data with the potential purchaser's preferences. The disclosed system may thus provide guidance to the potential purchaser that Supplier 3 represents the best match.

FIG. 5 further illustrates a set of Upstream Outcome Scores 520, which may be calculated substantially similarly to the outcome scores 510. For simplicity, the illustrated embodiment does not include the scores for the upstream suppliers; rather, only the upstream outcome scores are illustrated. The disclosed system may not provide any aggregation of the up-stream scores 522, 524, and 526 with the corresponding supplier scores 512, 514, and 516. The system may simply enable the potential purchaser to determine the weight to give to the calculated up-stream environmental impact scores, and may enable the purchaser to proceed accordingly. As discussed above, the disclosed system may alternatively display only a single set of scores (i.e., one score for each supplier) wherein each score includes an aggregation of the up-stream supplier environmental impact data and the supplier environmental impact data.

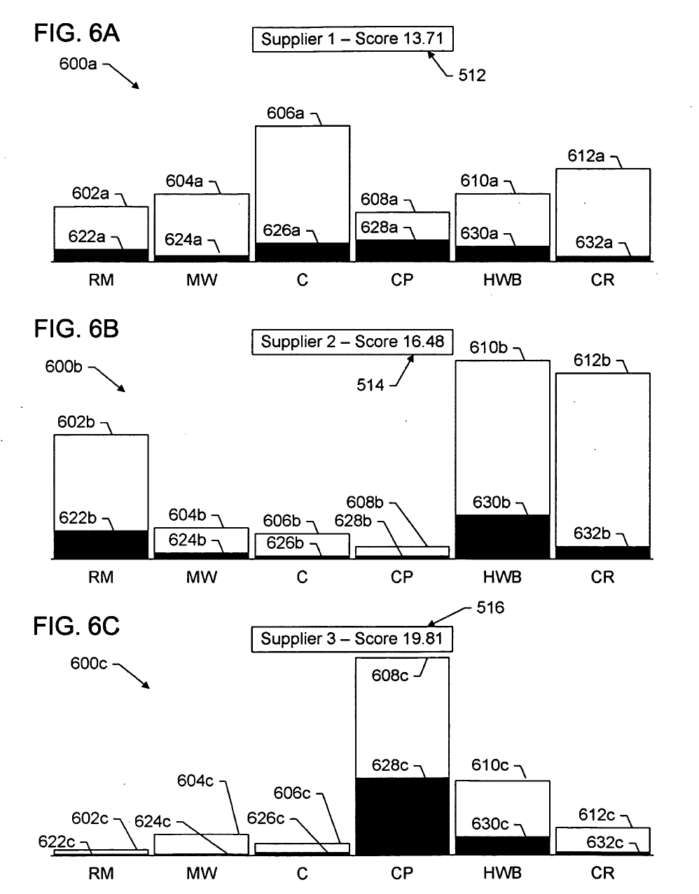

FIGS. 6A, 6B, and 6C illustrate example bar graphs 600a, 600b, and 600c representing the normalized data for each of the environmental impact categories of each of Supplier 1, Supplier 2, and Supplier 3 which has granted appropriate permission to the potential purchaser, as well as the contribution of each category to that supplier's outcome score when viewed in the context of the weighting values entered by the potential purchaser. It should be appreciated that because the bars of the graphs 600a, 600b, and 600c represent data which has been normalized such as through the use of a normalization curve, the bars attributable to each of the Suppliers are comparable against each other to determine relative environmental impacts for each category of data.

Specifically, FIG. 6A illustrates the contribution of each of six environmental impact categories to the outcome score of Supplier 1. As illustrated in FIGS. 5 and 6A by numeral 512, the disclosed system calculated an outcome score of 13.71 for Supplier 1. Bars 602a, 604a, 606a, 608a, 610a, and 612a of the bar chart 600a illustrate Supplier 1's scores for each of the six environmental impact categories 404a, 406a, 408a, 410a, 412a, and 414a. For example, as illustrated in FIGS. 5 and 6A, Supplier 1 had a highest environmental impact score for the Conservation category, illustrated by bar 606a. It should be appreciated that, as discussed above, the supplier scores for the six environmental impact categories represent normalized scores, generated using a normalization curve or other suitable normalization technique.

Bars 622a, 624a, 626a, 628a, 630a, and 632a illustrate the contribution of each of the six environmental impact categories to Supplier 1's outcome score 512, after the weighting values provided by the potential purchaser are applied to the data. Thus, it should be appreciated that despite Supplier 1's overall environmental impact score for Conservation 606a being substantially higher than its environmental impact score for the Clean Production category 608a, because the potential purchaser values Clean Production substantially more than it values Conservation, Supplier 1's Clean Production category environmental impact score, when weighted according to the potential purchaser's customized preferences, contributes more to the outcome score than Supplier 1's purchaser-specific Conservation score.

FIG. 6B illustrates the contribution of each of six environmental impact categories to the outcome score of Supplier 2. As illustrated in chart 600b, Supplier 2's outcome score of 16.48, represented by numeral 514, is primarily attributable to the contribution of the Human Well Being score. It should be appreciated that the outcome score of Supplier 2 would have been substantially better had the interests of the purchaser aligned more completely with the strengths of Supplier 2—namely, had the purchaser attached more importance to the Human Well Being and Credible Reporting environmental impact categories. Had the purchaser so attached its preferences, the relatively higher scores 610b and 612b for Supplier 2 would have contributed in a more substantial way to the outcome score 504.

FIG. 6C illustrates the contribution of each of six environmental impact categories to the outcome score of Supplier 3. As illustrated, Supplier 3's strength (i.e., its Clean Production environmental impact score) aligns substantially with the potential purchaser's preference, as indicated by the weighted value of 40%, for high Clean Production scores. Thus, as illustrated, the bar 608c representing Clean Production contributes substantially, as illustrated by bar 628c, to the Supplier 3 outcome score of 19.81, represented by numeral 516. It should be further appreciated that in the illustrated embodiment, the Supplier with the highest outcome score (i.e., Supplier 3) corresponds to the supplier whose strengths most closely align with the preferences of the potential purchaser. Specifically, Supplier 3 has a relatively high score for the Clean Production category, which is the category to which the potential purchaser attaches the most importance. It should be appreciated that the relatively large contribution, represented by bar 628c, results in Supplier 3 having the highest outcome score of the three analyzed Suppliers.

It should be appreciated that the disclosed system may be implemented in any suitable networked or non-networked configuration. For example, the disclosed system may be implemented in a server to which a plurality of terminals are connected via one or more network interface devices. The server may enable a plurality of suppliers and/or a plurality of potential purchasers to access the data provided by other suppliers and/or other potential purchasers by interacting with the server via the one or more network interface devices. Alternatively, the disclosed system may be implemented as one or more computer terminals to which one or more entities (i.e., suppliers and/or potential purchasers) has physical access. For example, the disclosed system may be implemented as a single computer terminal at a large paper distribution facility. In this embodiment, the disclosed system may enable two or more entities to separately log in to the system and provide data for use in calculating outcome scores by inputting the data using an input device such as a keyboard and/or mouse.

In summary, a system and methods for generating a plurality of outcome scores based on customized weighing data entered by a potential purchaser and based on normalized environmental impact data entered by a plurality of suppliers have been provided. It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of quantifying an environmental impact of a supplier, the method comprising:
(a) enabling a supplier to input first environmental data for a first environmental impact category, second environmental impact data for a second environmental impact category, and associated permission data granting permission to at least one potential purchaser;
(b) enabling the supplier to indicate an up-stream entity;
(c) enabling the up-stream entity to input up-stream environmental data;
(d) generating a normalized data set for the supplier based on at least one normalization curve, the first environmental data, and the second environmental data;
(e) generating a normalized up-stream data set for the supplier, the normalized up-stream data set being based on the up-stream environmental data;
(f) enabling the potential purchaser to indicate a first relative weight for the first environmental impact category and a second relative weight for the second environmental impact category; and
(g) if the associated permission data for the supplier grants permission to the potential purchaser:
(i) calculating a supplier outcome score based on the first relative weight, the second relative weight, and the normalized data set,
(ii) calculating an up-stream outcome score based on the first relative weight, the second relative weight, and the normalized up-stream data set,
(iii) displaying the supplier outcome score, and
(iv) displaying the up-stream outcome score.

2. The method of claim 1, wherein the supplier is a first supplier, the supplier outcome score is a first supplier outcome score, and the upstream outcome score is a first upstream outcome score, and which also includes calculating a second supplier outcome score and a second upstream outcome score for a second supplier.

3. The method of claim 2, which includes determining a preferred supplier between the first supplier and the second supplier, the determination being based on at least one selected from the group consisting of a comparison between the first supplier outcome score and the second outcome score and a comparison between the first up-stream outcome score and the second up-stream outcome score.

4. The method of claim 1, wherein the up-stream environmental data is associated with either the first environmental impact category or the second environmental impact category.

5. The method of claim 1, wherein enabling the potential purchaser to indicate the first relative weight includes enabling the potential purchaser to provide an input to move a displayed slider.

6. The method of claim 1, wherein enabling the potential purchaser to indicate the first relative weight includes enabling the potential purchaser to provide an input representing a numeral indicative of the first relative weight.

7. The method of claim 1, wherein a sum of the first relative weight and the second relative weight is equal to a predetermined total quantity of points.

8. The method of claim 1, wherein calculating the outcome score is also based on a credit attributable to the supplier.

9. The method of claim 8, wherein the credit is based on a technological asset owned by the supplier.

10. The method of claim 9, wherein the technological asset is at least one selected from the group consisting of: a pollution reduction device, a factory, and a production machine.

11. The method of claim 8, wherein the credit is based on information provided by the potential purchaser.

12. The method of claim 11, wherein the information provided by the potential purchaser represents an assignment of value by the potential purchaser to an activity of the supplier.

13. The method of claim 8, wherein the credit is based on a report generated by a third party about a manufacturing capability of the supplier.

14. The method of claim 1, which includes storing the first relative weight and the second relative weight as a first weight set, which includes enabling potential purchaser to indicate a third relative weight for the first environmental impact category and a fourth relative weight for the second environmental impact category, and which includes storing the third relative weight and the fourth relative weight as a second weight set.

15. The method of claim 14, which includes enabling the potential purchaser to indicate one of the first weight set and the second weight set and which further includes calculating the outcome score based on the indicated weight set.

16. A method of quantifying an environmental impact of a supplier, the method comprising:
(a) enabling a supplier to input first environmental data for a first environmental impact category, a second environmental impact data for a second environmental impact category, and associated permission data granting permission to at least one potential purchaser;
(b) enabling the supplier to indicate an up-stream entity;
(c) enabling the up-stream entity to input up-stream environmental data;
(d) generating a normalized data set for the supplier, the normalized data set being based on the first environmental data, the second environmental data, and the up-stream environmental data;
(e) enabling the potential purchaser to indicate a first relative weight for the first environmental impact category and a second relative weight for the second environmental impact category; and
(f) if the permission data associated with the supplier grants permission to the potential purchaser:
(i) calculating an outcome score based on the first relative weight, the second relative weight, and the normalized data set, and
(ii) displaying the outcome score.

17. The method of claim 16, wherein the up-stream environmental data is associated with either the first environmental impact category or the second environmental impact category.

18. The method of claim 16, wherein generating the normalized data set for the supplier includes applying an industry average to the first environmental data, the second environmental data, and the up-stream environmental data.

19. The method of claim 16, wherein generating a normalized data set for the supplier includes attributing a portion of the first environmental data, the second environmental data, or the up-stream environmental data to a product to be purchased.

20. The method of claim 16, wherein generating a normalized data set for the supplier includes applying at least one normalization curve to at least one selected from the group consisting of the first environmental data, the second environmental data, and the up-stream environmental data.

21. The method of claim 16, wherein enabling the potential purchaser to indicate the first relative weight includes enabling the potential purchaser to provide an input to slide a slider input.

22. The method of claim 16, wherein enabling the potential purchaser to indicate the first relative weight includes enabling the potential purchaser to input a numeral representing the first relative weight.

23. The method of claim 16, wherein a sum of the first relative weight and the second relative weight is equal to a total quantity of points.

24. The method of claim 16, wherein calculating the outcome score is additionally based on a credit attributable to the supplier.

25. The method of claim 24, wherein the credit is based on a technological asset owned by the supplier.

26. The method of claim 25, wherein the technological asset is at least one selected from the group consisting of: a pollution reduction device, a factory, and a production machine.

27. The method of claim 25, wherein the credit is applied based on a credit input provided by the potential purchaser.

28. The method of claim 27, wherein the credit input represents an assignment of value by the potential purchaser to an activity of the supplier.

29. The method of claim 24, wherein the credit is based on at least one report generated by a third party about a manufacturing capability of the supplier.

30. The method of claim 16, which includes storing the first relative weight and the second relative weight as a first weight set, which includes enabling potential purchaser to indicate a third relative weight for the first environmental impact category and a fourth relative weight for the second environmental impact category, and which includes storing the third relative weight and the fourth relative weight as a second weight set.

31. The method of claim 16, which includes enabling the potential purchaser to indicate one of the first weight set and the second weight set, and which includes calculating the outcome score based on the indicated weight set.

32. The method of claim 16, wherein the potential purchaser is a first potential purchaser, and wherein the supplier is a second potential purchaser.

33. An environmental impact determination system comprising:
at least one network interface device;
at least one processor; and
at least one memory device which stores a plurality of instructions, which when executed by the at least one processor, cause the at least one processor to operate with the at least one network interface device to:
(a) enable a supplier to input first environmental data for a first environmental impact category, second environmental impact data for a second environmental impact category, and associated permission data granting permission to at least one potential purchaser,
(b) enable an up-stream entity to input up-stream environmental data,
(c) generate a normalized data set for the supplier based on at least one normalization curve, the first environmental data, and the second environmental data,
(d) generate a normalized up-stream data set for the supplier, the normalized up-stream data set being based on the up-stream environmental data,
(e) enable the potential purchaser to indicate a first relative weight for the first environmental impact category and a second relative weight for the second environmental impact category, and
(f) if the associated permission data for the supplier grants permission to the potential purchaser:
(i) calculate a supplier outcome score based on the first relative weight, the second relative weight, and the normalized data set,
(ii) calculate an up-stream outcome score based on the first relative weight, the second relative weight, and the normalized up-stream data set,
(iii) display the supplier outcome score, and
(iv) display the up-stream outcome score.

34. The environmental impact determination system of claim 33, wherein the instructions cause the at least one processor to calculate the outcome score based on a credit attributable to the supplier.

35. The environmental impact determination system of claim 34, wherein the credit is based on information provided by the potential purchaser.

36. The environmental impact determination system of claim 35, wherein the information provided by the potential purchaser represents an assignment of value by the potential purchaser to an activity of the supplier.

37. The environmental impact determination system of claim 34, wherein the credit is based on a report generated by a third party about a manufacturing capability of the supplier.

38. An environmental impact determination system comprising:
at least one network interface device;
at least one processor; and
at least one memory device which stores a plurality of instructions, which when executed by the at least one processor, cause the at least one processor to operate with the at least one network interface device to
(a) enable a supplier to input first environmental data for a first environmental impact category, a second environmental impact data for a second environmental impact category, and associated permission data granting permission to at least one potential purchaser;
(b) enable the supplier to indicate an up-stream entity;
(c) enable the up-stream entity to input up-stream environmental data;
(d) generate a normalized data set for the supplier, the normalized data set being based on the first environmental data, the second environmental data, and the up-stream environmental data;
(e) enable the potential purchaser to indicate a first relative weight for the first environmental impact category and a second relative weight for the second environmental impact category; and
(f) if the permission data associated with the supplier grants permission to the potential purchaser:
(i) calculate an outcome score based on the first relative weight, the second relative weight, and the normalized data set, and
(ii) display the outcome score.

39. The environmental impact determination system of claim 38, wherein generating a normalized data set for the supplier includes attributing a portion of the first environmental data, the second environmental data, or the up-stream environmental data to a product to be purchased.

40. The environmental impact determination system of claim 38, wherein the instructions cause the at least one processor to generate the normalized data set for the supplier by applying at least one normalization curve to at least one selected from the group consisting of the first environmental data, the second environmental data, and the up-stream environmental data.

41. The environmental impact determination system of claim 38, wherein the instructions cause the at least one processor to calculate the outcome score based on a credit attributable to the supplier.

42. The environmental impact determination system of claim 41, wherein the credit is based on a credit input provided by the potential purchaser.

43. The environmental impact determination system of claim 42, wherein the credit input represents an assignment of value by the potential purchaser to an activity of the supplier.
